(19) United States
(12) Patent Application Publication
(10) Pub. No.: US 2026/0268561 A1
(43) Pub. Date: Sep. 10, 2026

(54) DUAL DIFFUSION MODELS FOR SPECTRAL COMPUTED TOMOGRAPHY RECONSTRUCTION AND DERIVATIVE IMAGES

(71) Applicant: Siemens Healthineers AG, Forchheim (DE)

(72) Inventors: Matthew Holbrook, Pennington, NJ (US); Mariappan S. Nadar, Plainsboro, NJ (US)

(21) Appl. No.: 19/071,905

(22) Filed: Mar. 6, 2025

(51) Int. Cl. G06T 11/00

(52) U.S. Cl. CPC G06T 12/20; G06T 12/30; G06T 2211/424; G06T 2211/441

(57) ABSTRACT

For spectral CT imaging, a diffusion model is used for forming a derivative image (2^{nd} step in the two-step approach). Separate diffusion models may be used for reconstruction of the CT image and forming the derivative image in spectral CT. The use of the diffusion model for reconstruction of the CT image limits noise and produces a quality CT image. The use of the diffusion model separately for forming the derivative image provides a quality derivative CT image.

### BACKGROUND

The present embodiments relate to reconstruction in computed tomography (CT) and spectral CT's associated derivative images. Spectral reconstructions denote multi-energy CT acquisitions from photon counting CT (PCCT) or dual energy CT systems. Derivative images are those derived from the multi-energy measurements and include material maps, monoenergetic images, and virtual non-contrast images. The process for creating derivative images depends on obtaining adequate spectral samples. The quality of the derivative images is rooted in the quality of the spectral reconstructions. Noise in spectral reconstructions is amplified when computing derivative images. Derivative maps are also affected by the spectral quality of acquisition. Poor spectral separation causes material to bleed together, making their separation or removal impossible.

Derivative maps may be created via a linear inversion operation, a process known as two-step reconstruction. To address noise and spectral overlap between measurements, this inversion is often performed along with heavy denoising and other constraints, such as non-negativity. As a method to increase the accuracy of derivative maps, a one-step spectral algorithm has been developed that reconstructs derivative images directly from raw CT data, which may also have a high computational cost and does not provide the standard CT reconstruction.

Deep learning models have been used in CT reconstruction for joint spectral denoising and to replace the material decomposition. Deep learning models have the benefit of being tuned to the training data rather than hand crafted and have shown benefits in performance and speed.

Within CT research, diffusion models have been used in iterative physics-based end-to-end reconstruction and even applied to multi-energy reconstruction with good gains with regards to image noise and sharpness. A diffusion model has been also used in one-step spectral reconstruction, directly reconstructing material maps from raw data with CT system models. The one-step method shows greater accuracy but does not provide the standard CT reconstruction. The two-step approach using the diffusion model in the first step may have poor performance for the derivative image.

### SUMMARY

By way of introduction, the preferred embodiments described below include methods, systems, instructions, and non-transitory computer readable media for CT imaging. A diffusion model is used for forming a derivative image (2^{nd} step in the two-step approach). Separate diffusion models may be used for reconstruction of the CT image and forming the derivative image in spectral CT. The use of the diffusion model for reconstruction of the CT image limits noise and produces a quality CT image. The use of the diffusion model separately for forming the derivative image provides a quality derivative CT image.

In a first aspect, a system is provided for CT imaging. A CT scanner is configured to output data representing an interior region of the patient. An image processor is configured to reconstruct a CT object from the output data with a first machine-learned diffusion model and a CT scanner model. The image processor is configured to reconstruct a derivative object from the CT object with a second machine-learned diffusion model and a derivative physics model. A display is configured to display an image of the derivative object.

In a second aspect, a method is provided for CT imaging. A spectral CT system scans a patient, providing spectral CT data representing the patient. An image processor reconstructs a CT image from the spectral CT data using a first trained diffusion model and forms a derivative image from the CT image using a second trained diffusion model. The derivative image is displayed.

In a third aspect, a method is provided for CT imaging. An image processor reconstructs a CT image from spectral CT data. The image processor forms a derivative image from the CT image using a first trained diffusion model. The derivative image is displayed.

Any one or more of the aspects or concepts summarized above or in the Illustrative Embodiments below may be used alone or in combination. The aspects or concepts described for one Illustrative Embodiment or aspect may be used in other embodiments or aspects. The aspects or concepts described for a method or system may be used in others of a system, method, or non-transitory computer readable storage medium. Any one or more of the aspects described above may be used alone or in combination.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of one embodiment of a method for CT imaging;

FIG. 2 illustrates an example pipeline for CT reconstruction and derivative image generation using multiple diffusion models; and

FIG. 3 is one embodiment of a system for CT imaging.

### DETAILED DESCRIPTION OF THE DRAWINGS AND PRESENTLY PREFERRED EMBODIMENTS

Deep learning is used in spectral CT reconstruction for high-quality reconstruction and derivative images. The two-step process for creating CT reconstruction and derivative images uses diffusion models for each step, or at least the derivative creation. A diffusion model is used to generate realistic spectral CT images. In tandem, a sister diffusion model is used produce high quality derivative images. Physics-based models of the CT system and the inversion processes for derivative images are used with the diffusion models in an arrangement that allows the diffusion models to be used with any physics model in a plug-and-play framework.

While both CT reconstruction and one-step derivative image approaches show image quality improvements, those methods do not provide both reconstruction and derivative maps within the same algorithm. By using both diffusion models, significant image quality gains from diffusion models are provided in both spectral reconstruction and derivative image maps. The image formation process is completed with higher efficiency.

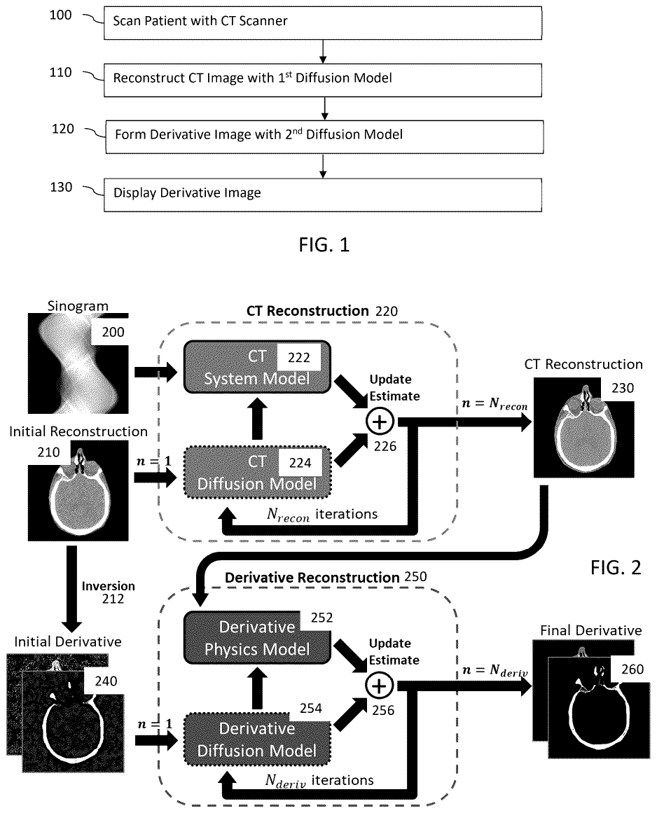

FIG. 1 is a flow chart of one embodiment of a method for CT imaging. A diffusion model is used in forming a derivative image in spectral CT from a reconstructed CT image (two-step approach). Another diffusion model may be used in reconstructing the reconstructed CT image.

FIG. 2 illustrates a pipeline using multiple diffusion models in the two-step approach. The pipeline represents an implementation of the method of FIG. 1, showing two steps for CT reconstruction and derivative image generation (reconstruction). Two sets of physics and diffusion models are used to produce a CT reconstruction followed a derivative image. In the examples below, the method of FIG. 1 is explained using the example pipeline of FIG. 2. In other examples, a different pipeline is used, such as not providing the CT reconstruction 220 with the diffusion model 224.

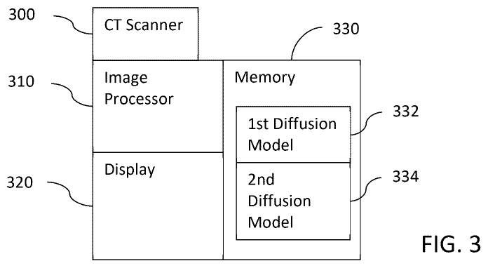

The medical imaging system performs the acts. A medical imager, such as a CT system (scanner), performs act 100. An image processor performs acts 110 and 120. The image processor uses a display screen to perform act 130. In one embodiment, the system of FIG. 3 performs the acts. In other embodiments, different devices perform any one or more of the acts. In one example, the CT system performs all the acts. In yet another example, a workstation, computer, portable or handheld device (e.g., tablet or smart phone), server, or combinations thereof performs one or more of the acts.

The acts are performed in the order shown (e.g., top to bottom or numerical) or other orders. Additional, different, or fewer acts may be provided. For example, the method is performed without act 100 and/or act 110, such as where a previously formed reconstruction is provided for performing acts 120 and 130. As another example, acts for configuring a CT scanner, such as for selecting the application and/or materials to be decomposed, are provided.

In act 100, a spectral CT system scans a patient. The spectral CT system includes an x-ray source or sources that may operate at different energies. Alternatively, or additionally, a detector allows for detection at different energies, such as having multiple detectors or thresholds applied to detected x-ray photons. Dual energy or photon counting CT systems may be used. Using spectral CT, measurements reconstructed in Hounsfield or other density or attenuation values from different energies may be used to derive material composition or other derivative information (e.g., monoenergetic information or virtual non-contrast information).

The scan provides data representing an interior region of the patient. Spectral CT data is provided by the spectral CT system. Other data may be provided by the spectral CT or other medical imaging system. After reconstruction, the data represents a planar region of the patient. A volume may be represented, such as a stack of slices or planar regions.

The data is a frame of data representing the patient. The data may be in any format. While the terms “image” and “imaging” are used, the image or imaging data may be in a format prior to actual display of the image. For example, the medical image may be a plurality of scalar values representing different locations in a Cartesian or polar coordinate format different than a display format (i.e., scan or voxel data). As another example, the medical image may be a plurality red, green, blue (e.g., RGB) values output to a display for generating the image in the display format. The medical image may not yet be a displayed image, may be a currently displayed image, or may be previously displayed image in the display or other format. The image or imaging is a dataset that may be used for anatomical imaging, such as scan data representing spatial distribution of anatomy of the patient.

The data is obtained by scanning the patient. The scan data may be provided in or by the medical scanner, loaded from memory, and/or by transfer via a computer network. For example, previously acquired scan data is accessed from a memory or database. As another example, scan data is transmitted over a network after acquisition from scanning a patient.

Data different than the scan data may be acquired. For example, task-specific information is acquired. The task-specific information may be an identification of the region scanned (e.g., body region or anatomy), existence of contrast agent in the scanned region, pathology information, scan settings (e.g., x-ray source energies, energy thresholds, photon count range, gantry position, range of movement, and/or reconstruction settings), and/or patient medical information. As another example, injection protocol information is acquired. The time of injection, the time of scan, the volume of contrast agent injected, the change in injection over time, the type of contrast agent, and/or other contrast agent information may be acquired. In yet another example, desired image characteristics, such as energy thresholds, resolutions, sharpness, or noise levels, are acquired. The image characteristics may be acquired from the imaging protocol used, the radiologist or other medical professional, defaults, from memory, a user interface, or another source.

In act 110, the image processor reconstructs a CT image from spectral CT data. Computed tomography converts the sinogram or other spectral CT data into a representation of the scanned object (patient). The CT image is an object representation. The object is represented in image space.

The reconstructed representation is a two-dimensional (2D) or three-dimensional (3D) representation. The 2D representation may be formed as pixels. A stack of planar (2D) representations or voxels may form the 3D representation.

In one approach, any spectral CT reconstruction of the CT image is performed. An iterative optimization fits the spectral CT data to a distribution of the object. Using forward and backward projection, an object is fit to the spectral CT data. The forward projection may use a model of the CT scanner. The object is varied to find the distribution that matches the spectral CT data. Any stop criteria or criterion may be used. The iterative reconstruction continues until the final reconstruction is generated.

The model of the CT scanner is a physics model. The physics-based model for the CT system performs reconstruction of raw data into an image. For added accuracy, the CT system model includes aspects of the system optics and/or geometries, physics, and statistics. Optics and/or geometries include x-ray focal spot, detector blur, collimation, magnification, and sampling. Physics aspects include x-ray spectrum, detector response, beam hardening, and scatter. Statistics aspects include photon statics and electronic noise. Any physics model for projecting between the scan space (spectral CT data) and the image space (reconstruction or object) may be used.

Different physics models represent different CT scanners. The values of variables, the variables used, and/or the model in the physics model depends on the design of the CT scanner.

In another approach, a diffusion model is included in the iterative reconstruction. FIG. 2 shows an example. The CT reconstruction 220 includes a CT system model 222 and a CT diffusion model 224. The diffusion model 224 is a generative model, providing an expected (generated) output in response to an input. A desired reconstruction (CT image or object) is output in response to an input, such as another reconstruction (CT image or object). The desired reconstruction may have less or no noise or other artifacts as compared to the input reconstruction. The desired reconstruction may have different contrast, resolution, or sharpness as compared to the input reconstruction. The diffusion model 224 may generate the output given other criteria, such as anatomy of interest. The expectation (e.g., the desired characteristic(s)) may be input. The diffusion model 224 may generate the output in response to an input characteristic with or without input of a reconstruction or spatial distribution. Due to training, the trained diffusion model 224 generates an expected or desired reconstruction given an input reconstruction and/or input characteristics.

The diffusion model is a machine-learned model. The machine-learned model is trained by a machine to receive an input and generate an output in response to the input. For reconstruction, the input reconstruction and output reconstruction are 2D or 3D. Other inputs may be included, such as the characteristics of the desired (expected) output.

Any machine learning or training may be used. A probabilistic boosting tree, support vector machine, neural network, sparse auto-encoding classifier, Bayesian network, or other now known or later developed machine learning may be used. Diffusion models are typically trained in a self-supervised manner, though any semi-supervised, supervised, or unsupervised learning may be used. Hierarchal or other approaches may be used.

In one embodiment, the classification and/or regression is by a machine-learned model learned with deep learning. Any deep learning approach or architecture may be used. For example, a convolutional neural network (CNN) is used. In one approach, the architecture of the model is a U-Net, encoder-decoder, attention network, transformer (e.g., hour-glass transformer), or another image-to-image neural network. The neural network may include convolutional, sub-sampling (e.g., max pooling), fully connected, and/or other types of layers. Other features may be added to the layers, such as non-imaging or clinical information. Any combination of layers may be provided. The architecture defines various learnable parameters, such as node weights, link weights, kernels, and/or activation variables.

For use in iteration, the same diffusion model 224 is used in each iteration. In other approaches, different diffusion models 224 are provided for different iterations.

Training data is used to identify the values for the learnable parameters that most consistently provide the appropriate output. The training data includes samples from one or more sources, such as synthetically generated inputs and outputs (e.g., from scanning phantoms and reconstructing using a known approach), inputs and outputs from patient medical records, inputs and outputs from simulation, and/or combinations thereof. In one approach, pre-training using simulated or synthetic inputs and outputs is performed, and then the model is refined by training with real patient data.

The training applies an optimization, such as Adam. The training samples of inputs and ground truth outputs are used to learn the values of the learnable parameters. Any loss comparing the output to the ground truth in training may be used, such as cross-entropy, L1, L2, or another loss. The training minimizes the loss through the training samples (data) by setting the values of the learnable parameters. Machine training identifies the values of the learnable parameters that result in generating the expected or desired output given the input across the range of possible inputs.

After the model is trained, the model is applied to previously unseen data. For a new patient, the input information (e.g., reconstructed object) is applied to the machine-learned model. The machine-learned model outputs the desired reconstruction. In the example of FIG. 2, the current reconstruction after N iterations (N_{recon}) are input to the CT diffusion model 224. In response to the input, an expected or desired reconstruction is output to the CT system model 222 for comparison to the spectral CT data (e.g., sinogram 200) from the scan of act 100.

In a further implementation, one or more image characteristics (e.g., contrast level) are input with the current reconstruction (CT object for N_{recon}). The diffusion model 224 is a conditional diffusion model, so includes a controller (e.g., hypernetwork) arranged to alter the kernels, weights, scaling, and/or attention of the neural network implementing the diffusion model 224. The controller may have values of parameters learned during training to condition the rest of the diffusion model 224 to generate the output (reconstruction) with one or more desired characteristics given the input (e.g., characteristic level and the current reconstruction). As a conditional diffusion model, the model is conditioned on reconstruction parameters to produce images with different energies/thresholds, resolutions, sharpness, noise levels, and/or other characteristics (e.g., type of anatomy). The resulting output reconstruction (CT object or image) is generated to reflect or more likely reflect the desired characteristic than in the input reconstruction.

For CT reconstruction, a single diffusion model is trained, but different models may be provided in other implementations.

The CT system model 222 and the diffusion model 224 are used together in one or more of the iterations for reconstructing the CT object 230. FIG. 2 shows one approach. The CT system model 222 receives the sinogram (spectral CT data) 200 and an expected (desired) CT image. The CT system model 222 uses projection to compare the expected CT image to the sinogram 200. The expected CT image is updated to more closely match an object providing the sinogram 200.

The diffusion model 224 receives in input CT object (e.g., reconstruction of N_{recon}). As a conditional diffusion model 224, the model 224 may also receive a value or values for one or more characteristics. In response to the input, the diffusion model 224 generates an expected CT image, which is provided to the CT system model 222 and the combiner 226.

The combiner 226 is a weighted average or other combination of the output CT objects of the CT system model 222 and the CT diffusion model 224. The combined CT object is provided as the CT object to the diffusion model 224. The final CT object 230 (output of the last iteration of the CT reconstruction 220) is output as the reconstruction of the scanned object.

The CT reconstruction 220 is iterative. For iterative reconstruction, the CT system model 222, diffusion model 224, and combiner 226 operate for each iteration or a sub-set of iterations. The raw sinogram 200 and a computationally cheap initial reconstruction estimate 210 (e.g., weighted filtered back projection (WFBP)) are inputs to the CT reconstruction 220. The initial reconstruction 210 serves as a starting point to aid convergence but is not used in other approaches. The initial reconstruction 210 is updated by the diffusion model 224. The updated CT object (expected CT object) is passed to the system model 222, which updates the estimate to be consistent with the raw measurements of the sinogram 200. Both diffusion and system updates are combined by the combiner 226 to complete the iteration. This process is then iterated N_{recon} times until convergence. Subsequent iterations use the combined CT object rather than the initial reconstruction 210 as the input to the diffusion model 224.

Other approaches for the CT reconstruction 220 with the system model 222 and the diffusion model 224 may be used. For example, the output of the physics model 222 is not combined with the output of the diffusion model 224. The diffusion model 224 directly receives the output of the system model 222.

In a plug-and-play approach, the physics model (e.g., CT system model 222) is separate from the CT diffusion model 224. The physics model may be changed, such as where a different CT scanner is to be used, while still using the same diffusion model 224. The diffusion model 224 is operable using any of different physics models 222 for different spectral CT systems.

In act 120 of FIG. 1, the image processor forms a derivative image from the CT image using a trained diffusion model. Any derivative image may be formed, such as a material decomposition (material map), monoenergetic image, or a virtual non-contrast image. The spectral information is used to generate one or more images derived from the CT reconstruction 230.

A monoenergetic image relies on material identification. The monoenergetic image uses the energy for a given material. Similarly, the contrast may be identified. The contrast is removed, providing the virtual non-contrast image (e.g., CT object as if contrast agent were not in the patient).

For material decomposition, the image processor determines the material composition for each of a plurality of locations, such as determining for each pixel or voxel location. The material decomposition may be a classification, such as identifying whether a given material exists at the location. The classification may be two material, three material, or four or more materials. The material decomposition is for material labeling, identifying whether one of two or more materials is at the location. Alternatively, or additionally, the material decomposition provides concentration, density, or relative amount (e.g., volume, attenuation, or density) of the different materials at each location. The concentration of each material for each location is determined.

Some example two material decompositions may be of bone and iodine (e.g., contrast agent), blood and plaque, kidney soft tissue and kidney stone, lung tissue and lung vessel, gout (e.g., uric acid crystals) and blood, brain hemorrhage (e.g., marrow and bone), heart pulmonary blood volume (PBV)(e.g., fat and soft tissue) or bone marrow (e.g., cerebrospinal fluid and hemorrhaging tissue). Some example three material decompositions may be liver virtual non-contrast (VNC) (e.g., fat, soft tissue, and iodine), lung PBV (e.g., air, soft tissue, and iodine), or virtual unenhanced (air, water, and iodine). Three material decompositions may allow for distinguishing between tissue and two or more different types of contrast agents. Any type of materials may be used in decomposition of two or more materials in the patient.

The derivative image relates to the spectral CT reconstruction. A model for converting or deriving is used. The model is a derivative physics model. The model may be a linear model, such as linear equations or a look-up table generated from linear equations. The physics-based model of the derivative image model creates the derivative image from the final CT reconstruction. This derivative model uses physical properties, such as the system spectral response, photon counting CT thresholds, and material attenuation curves, to relate the spectral CT reconstruction to the derivative image.

Different models are provided for different derivative images, such as different derivative physics models for each of material decomposition, monoenergetic image, and virtual non-contrast agent image. For material decomposition, different derivative physics models may be provided for different two, three, or more material decompositions.

The derivative model is used in a second step to create the derivative image from the CT reconstructed object of the first step. The derivative image is reconstructed from the CT image using the derivative model. In one approach, the derivative model alone is used to reconstruct the derivative image. In another approach, an iterative reconstruction is performed using interaction between the derivative physics model and another diffusion model.

The diffusion model is a machine-learned model. The same or different architecture is used for the diffusion model for creating the derivative image than for the diffusion model for CT reconstruction. For example, a different image-to-image (e.g., U-Net, transformer, or encoder-decoder) network is defined. Training data is collected from patients, synthesis, and/or simulation, and used to train the derivative diffusion model. Since the inputs are CT objects and the output are derivative images, different training data is collected and used to train the derivative diffusion model than for the CT reconstruction diffusion model. Training data for each derivative diffusion model may be obtained as a mix of simulated (e.g., for pretraining) and high-quality real patient data.

Like the derivative physics model, different diffusion models are provided for different derivative images, such as different derivative diffusion models for each of material decomposition, monoenergetic image, and virtual non-contrast agent image. For material decomposition, different derivative diffusion models may be provided for different two, three, or more material decompositions. For derivative images, separate models are trained to produce different categories of images: one for each set of material maps (water/calcium, water/iodine, etc.), one for monoenergetic images, and/or one for virtual non-contrast images. In alternative approaches, the same diffusion model may be used for different types of derivative images.

In one approach, the derivative diffusion model is a conditional diffusion model. One or more values for a corresponding one or more image characteristics are input to the derivative diffusion model. The characteristics are used to condition the diffusion model for generating the derivative image with a desired level of the characteristic(s). The derivative diffusion model is conditioned on reconstruction parameters to produce images with different energies/thresholds, resolutions, sharpness, noise levels, and/or other characteristics.

After the model is trained, the model is applied to previously unseen data. For a new patient, the input information (e.g., reconstructed object) is applied to the machine-learned model. The machine-learned model outputs the desired derivative image. In the example of FIG. 2, the current derivative reconstruction 250 after N iterations (N_{deriv}) are input to the derivative diffusion model 254. In response to the input, an expected or desired derivative reconstruction is output to the derivative physics model 252, which performs the derivation using the spectral CT reconstruction 230 as a data consistency check with the output derivation of the derivative diffusion model 254. The derivative physics model 252 generates an output derivation image with changes to the diffusion model 254 created derivation image to account for data consistency.

In a further implementation, one or more image characteristics (e.g., contrast level) are input with the current reconstruction (derivative object for N_{deriv}). The derivative diffusion model 254 is a conditional diffusion model, so includes a controller (e.g., hypernetwork) arranged to alter the kernel, weights, scaling, and/or attention of the neural network implementing the derivative diffusion model 254. The controller may have values of parameters learned during training to condition the rest of the diffusion model 254 to generate the output (derivative image) with one or more desired characteristics given the input (e.g., characteristic level and the current reconstruction). For derivative reconstruction, a single diffusion model is trained, but different models may be provided in other implementations. As a conditional diffusion model, the model is conditioned on reconstruction parameters to produce images with different energies/thresholds, resolutions, sharpness, noise levels, and/or other characteristics (e.g., type of anatomy). The resulting output reconstruction (derivative object or image) is generated to reflect or more likely reflect the desired characteristic than in the input reconstruction.

The derivative physics model 252 and the derivative diffusion model 254 are used together in one or more of the iterations for reconstructing the derivative object (image) 260. FIG. 2 shows one approach. The derivative physics model 252 receives the CT reconstruction (object or image) 230. The derivative physics model 252 uses the linear equations or other logic relating the spectral CT reconstruction 230 to the derivation (e.g., material decomposition), creating a derivative image. This derivative image is compared to the derivative image from the derivative diffusion model 254. The derivative image from the diffusion model 254 is updated for data consistency and output by the derivative physics model 252.

The derivative diffusion model 254 receives an input the derivative object (e.g., reconstruction of N_{deriv}). As a conditional diffusion model 254, the model 254 may also receive a value or values for one or more characteristics. In response to the input, the diffusion model 254 generates an expected derivative image, which is provided to the derivative physics model 252 and the derivative combiner 256.

The derivative combiner 256 is a weighted average or other combination of the output derivative object of the derivative physics model 252 and the derivative diffusion model 254. The combined derivative object is provided as the derivative object to the diffusion model 254. The final derivative object 260 (output of the last iteration of the derivative reconstruction 250) is output as the derivative image of the scanned object.

The derivative reconstruction 250 is iterative. For iterative reconstruction, the derivative physics model 252, derivative diffusion model 254, and derivative combiner 256 operate for each iteration or a sub-set of iterations. The spectral CT reconstruction 230 and a derivative image 240 created by an inversion 212 from the initial reconstruction 210 are inputs to the derivative reconstruction 250. The inversion 212 may be the derivative physics model 252, using linear equations or other physics modeling, to derive the initial derivative 240 from the initial reconstruction 210. This initial derivative 240 serves as a starting point to aid convergence but is not used in other approaches. The initial derivative 240 first is updated by the derivative diffusion model 254. The updated derivative object is passed to the derivative physics model 252, which performs a data consistency check with a derivation from the spectral CT reconstruction 230. Both diffusion and physics updates are combined by the combiner 256 to complete the iteration. This process is then iterated N_{deriv} times until convergence. Subsequent iterations use the combined derivative object rather than the initial derivative 240 as the input to the derivative diffusion model 254.

Other approaches for the derivative reconstruction 250 with the derivative physics model 252 and the derivative diffusion model 254 may be used. For example, the output of the physics model 252 is not combined with the output of the diffusion model 254. The diffusion model 254 directly receives the output of the derivative physics model 252.

In a plug-and-play approach, the physics model (e.g., derivative physics model 252) is separate from the derivative diffusion model 254. The physics model may be changed, such as where a different derivation is to be used, while still using the same derivative diffusion model 254. The derivative diffusion model 254 is operable using any of different physics models 252 for different derivations to create the same information (e.g., a given two-material material decomposition).

In act 130 of FIG. 1, the image processor generates and a display displays the derivative image. The derivation image may be transmitted to the display (e.g., a monitor, workstation, printer, handheld, or computer). Alternatively, or additionally, the transmission is to a memory, such as a database of patient records, or to a network, such as a computer network.

The derivative image as output is displayed or is further processed, which further processed derivative image is displayed. For example, the material decomposition maps are used to highlight locations of a particular material on an image of tissue. The derivative image may be visualized on the CT scanner or on another device, such as an imaging workstation.

In one approach, the derivation image is of one material. For example, a distribution of locations labeled for the material is displayed. Images for distribution of other materials may be displayed. Material maps for the different materials are generated as images and displayed. Alternatively, different materials modulate different aspects of a same image, such as using different colors for different materials. The one image shows spatial distributions of the different materials, such as spatial distribution of two different contrast agents with or without bone. Any material decomposition imaging may be used. Images of other derivations (e.g., monoenergetic or virtual non-contrast) may be displayed.

Images showing material composition at different times relative to an injection initiation may be generated and displayed. A video of material decomposition as a function of time may be provided. The variation over time of material decomposition for a single location or line of locations may be displayed as a graph or graphs.

Quantities may be calculated from the material decompositions, such as an area or volume. The quantities may be displayed as derivation images with or separately from the spatial representation, derivation images. The material decomposition image or images may be overlaid on or displayed adjacently to a CT image of the patient tissue without material decomposition.

One or more images from the CT reconstruction may be generated and displayed. For example, a planar image or multi-planar reconstruction images from the reconstructed CT volume are displayed. The CT images of tissue are displayed alone or with other information, such as the derivative image.

The derivative image and/or CT image are 2D, representing an area of the patient. A multi-planar reconstruction showing two or more areas may be generated and displayed. In other approaches, a volume or surface rendering from the CT reconstruction or the derivation reconstruction is performed and displayed as the image(s).

FIG. 3 shows a system for CT imaging. The system implements the method of FIG. 1, the pipeline of FIG. 2, or another method to output a derivative image for an interior region of a patient. The two-step process is used, first spectral CT reconstruction and then derivation from the spectral CT reconstruction. A diffusion model is used in at least the derivation.

The system includes a spectral CT scanner 300, an image processor 310, a memory 330, a display 320, and one or more machine-learned diffusion models 332, 334. Additional, different, or fewer components may be provided. For example, a network or interface connection is provided, such as for networking with a medical imaging network or data archival system or networking between the scanner 300 and the image processor 310. In another example, a user input (e.g., keyboard, touch screen, mouse, trackball, touch pad, joystick, buttons, and/or sliders) is provided for input of an imaging characteristic or reconstruction setting. As another example, a server is provided for implementing the image processor 310 and/or models 332, 334 remotely from the scanner 300.

The image processor 310, memory 330, display 320, and/or models 332, 334 are part of the medical scanner 300. Alternatively, the image processor 310, memory 330, display 320, and/or models 332, 334 are part of an archival and/or image processing system, such as associated with a medical records database workstation or server, separate from the CT scanner 300. In other embodiments, the image processor 310, memory 330, display 320, and/or models 332, 334 are a personal computer, such as desktop or laptop, a workstation, a server, a network, or combinations thereof.

The CT scanner 300 is a medical diagnostic CT imaging scanner for material decomposition. For example, the CT scanner 300 is a spectral CT scanner operable to transmit and/or detect radiation at different energies. A gantry supports a source or sources of x-rays and supports a detector or detectors on opposite sides of a patient examination space from the source or sources. The gantry moves the source(s) and detector(s) about the patient to perform a CT scan. Various x-ray projections are acquired by the detector from different positions relative to the patient. The CT scanner 300 is configured by an application and/or settings to output data representing an interior region of the patient. The CT scanner 300 scans the patient, providing a sinogram with information at different energies. Computed tomography solves for the two or three-dimensional distribution of the response from the projections, reconstructing the scan data into a spatial distribution of density or attenuation of the patient.

The memory 330 may be a graphics processing memory, a video random access memory, a random-access memory, system memory, cache memory, hard drive, optical media, magnetic media, flash drive, buffer, database, combinations thereof, or other now known or later developed memory device for storing data. The memory 330 is part of the medical scanner 300, part of a computer associated with the image processor 310, part of a database, part of another system, a picture archival memory, or a standalone device.

The memory 330 stores patient data, such as scan data, scan characteristics (e.g., settings or other task-specific information), and/or injection information. Any of the patient data discussed herein may be stored, such as values for features in the machine-learned model, initial reconstruction, CT reconstruction, initial derivation, derivations, updates, and/or other information used to generate the derivation image or reconstruction. Training data may be stored. Model parameters or values for generating the training data may be stored. The memory 330 alternatively or additionally stores weights, connections, filter kernels, and/or other information embodying one or more machine-learned models (e.g., the diffusion models 332, 334). The memory 330 may alternatively or additionally store data during processing, such as storing information discussed herein or links thereto.

The memory 330 or other memory is alternatively or additionally a non-transitory computer readable storage medium storing data representing instructions executable by the programmed image processor 310 or a processor implementing the models 332, 334. The instructions for implementing the processes, methods and/or techniques discussed herein are provided on non-transitory computer-readable storage media or memories, such as a cache, buffer, RAM, removable media, hard drive, or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The image processor 310 is a general processor, central processing unit, control processor, graphics processing unit, graphics processor, digital signal processor, three-dimensional rendering processor, application specific integrated circuit, field programmable gate array, artificial intelligence processor, digital circuit, analog circuit, combinations thereof, or other now known or later developed device for reconstructing spectral CT and derivation images by applying the diffusion models 332, 334. The image processor 310 is a single device or multiple devices operating in serial, parallel, or separately. The image processor 310 may be a main processor of a computer, such as a laptop or desktop computer, or may be a processor for handling some tasks in a larger system, such as in the medical scanner 300. The image processor 310 is configured by instructions, design, hardware, and/or software to perform the acts discussed herein.

The image processor 310 is configured to reconstruct a CT object from the output data with a machine-learned diffusion model 332 and a CT scanner model. The output data is the scan data, such as raw CT data (e.g., sinogram). The CT scanner model is a physics model of the CT scanner. The CT object is reconstructed as a spectral CT representation of the tissue of the patient. The image processor 310 reconstructs the CT object iteratively. For each iteration, the CT scanner model relates the output data to an output of the machine-learned diffusion model 332, where the output of the machine-learned diffusion model 332 is generated from the CT object. The diffusion model 332 generates an expected or desired CT object, and the CT scanner model is used for data consistency. In alternative embodiments, the CT reconstruction does not use the machine-learned diffusion model 332.

The image processor 310 is configured to reconstruct a derivative object from the CT object with a machine-learned diffusion model 334 and a derivative physics model. The derivative physics model is one or more linear solutions of physical properties relating the CT object to the derivative object. For example, the derivative physics model models material decomposition using spectral (multi-energy) information. The image processor 310 reconstructs the derivative object iteratively. For each iteration, the derivative physics model 334 relates the CT object to an output of the machine-learned diffusion model 334, performing a data consistency check. The output of the machine-learned diffusion model 334 is generated from the derivative object.

The derivative object is reconstructed as a material map, a monoenergetic object, or a virtual non-contrast object. The machine-learned diffusion model 334 is configured by training for reconstruction of the particular material map (e.g., bone and iodine). Different machine-learned diffusion models are used for reconstruction of different derivatives (e.g., other material maps, monoenergetic, or virtual non-contrast).

The diffusion models 332, 334 may be used with different physics models. The CT scanner model and/or the derivative physics models may be updated or replaced while using the same diffusion models 332, 334.

One or both diffusion models 332, 334 may be conditional diffusion models. A controller, such as a hypernetwork or neural network, receives input reconstruction parameters (e.g., image characteristics) and conditions (e.g., bias, scales, sets attention, and/or select kernels) the remaining neural network to operate based on the input reconstruction parameters. For example, the anatomy, energy (threshold), resolution, sharpness level, and/or noise level are input. The diffusion model 332, 334 is conditioned to generate an expected or desired image. Due to the conditioning, the generated image may more likely reflect the anatomy, energy, resolution, sharpness, and/or noise input. The diffusion model 332, 334 was trained to operate over a range of possible situations by conditioning as well as learning values of the learnable parameters.

The display 320 is a monitor, LCD, projector, plasma display, CRT, printer, or other now known or later developed devise for outputting visual information. The display 320 receives images of the derivative object (e.g., images of one or more materials from the material decomposition). The material decomposition or other derivative images are displayed on the display 320. Graphics, text, quantities, spatial distribution of anatomy, or other information from the image processor 310, memory 330, or CT scanner 300 may be displayed. An image of the CT object may be displayed, with or without the image of the derivative object. An image of the CT object overlaid with or highlighted based on the derivative object may be displayed.

Listed below are various Illustrative Embodiments. The Illustrative Embodiments summarize different combinations of aspects. Other combinations of any of the aspects with any other one or more of the aspects may be provided. Aspects from one type (e.g., method or system) may be used in another type (system or method).

Illustrative Embodiment 1. A system for computed tomography (CT) imaging, the system comprising: a CT scanner for scanning a patient, the medical scanner configured to output data representing an interior region of the patient; an image processor configured to reconstruct a CT object from the output data with a first machine-learned diffusion model and a CT scanner model, the image processor configured to reconstruct a derivative object from the CT object with a second machine-learned diffusion model and a derivative physics model; and a display configured to display an image of the derivative object.

Illustrative Embodiment 2. The system of Illustrative Embodiment 1, wherein the display is configured to display the image of the derivative object and the CT object.

Illustrative Embodiment 3. The system of claim 1, wherein the image processor is configured to reconstruct the CT object as a spectral CT representation, and wherein the image processor is configured to reconstruct the derivative object as a material map, a monoenergetic object, or a virtual non-contrast object.

Illustrative Embodiment 4. The system of Illustrative Embodiment 3, wherein the derivative object is a material map and wherein the second machine-learned diffusion model was configured by training for the reconstruction of the material map.

Illustrative Embodiment 5. The system of Illustrative Embodiment 4, wherein the image processor is configured to reconstruct the material map and the monoenergetic object or the virtual non-contrast object, wherein a third machine-learned diffusion model is used for the reconstruction of the monoenergetic object or the virtual non-contrast object.

Illustrative Embodiment 6. The system of claim 4, wherein the image processor is configured to reconstruct the material map with the second machine-learned diffusion model and an additional material map, wherein a third machine-learned diffusion model is used for the reconstruction of the additional material map.

Illustrative Embodiment 7. The system of claim 1, wherein the CT scanner model comprises a physics model of the CT scanner, and wherein the first and second machine-learned diffusion models are operable with different physics models including the physics model of the CT scanner and the derivative physics model.

Illustrative Embodiment 8. The system of claim 1, wherein the first machine-learned diffusion model comprises a conditional diffusion model.

Illustrative Embodiment 9. The system of Illustrative Embodiment 8, wherein the conditional diffusion model comprises an input for anatomy identification, energy, resolution, sharpness, or noise levels.

Illustrative Embodiment 10. The system of claim 1, wherein the derivative physics model comprises linear solutions of physical properties relating the CT object to the derivative object.

Illustrative Embodiment 11. The system of claim 1, wherein the image processor is configured to reconstruct the CT object iteratively where, for each iteration, the CT scanner model relates the output data to an output of the first machine-learned diffusion model, where the output of the first machine-learned diffusion model is generated from the CT object; and wherein the image processor is configured to reconstruct the derivative object iteratively where, for each iteration, the derivative physics model relates the CT object to an output of the second machine-learned diffusion model, where the output of the second machine-learned diffusion model is generated from the derivative object.

Illustrative Embodiment 12. A method for computed tomography (CT) imaging, the method comprising: scanning, by a spectral CT system, a patient, the scanning providing spectral CT data representing the patient; reconstructing, by an image processor, a CT image from the spectral CT data using a first trained diffusion model; forming, by the image processor, a derivative image from the CT image using a second trained diffusion model; and displaying the derivative image.

Illustrative Embodiment 13. The method of Illustrative Embodiment 12, wherein reconstructing comprises reconstructing iteratively using the first trained diffusion model and a physics model of the spectral CT system.

Illustrative Embodiment 14. The method of Illustrative Embodiment 13, wherein reconstructing is operable using the first trained diffusion model and different physics models of different spectral CT systems.

Illustrative Embodiment 15. The method of claim 12, wherein forming comprise forming iteratively using the second trained diffusion model and a derivative physics model.

Illustrative Embodiment 16. The method of Illustrative Embodiment 15, wherein forming comprises forming the derivative image and an additional derivative image, the derivative image formed with the second trained diffusion model and the additional derivative image formed with a third trained diffusion model.

Illustrative Embodiment 17. The method of claim 12, wherein the first and second trained diffusion models comprise conditional diffusion models, wherein reconstructing comprises inputting a first image characteristic to the conditional diffusion model of the first trained diffusion model, and wherein forming comprises inputting a second image characteristic to the conditional diffusion model of the second trained diffusion model.

Illustrative Embodiment 18. A method for computed tomography (CT) imaging, the method comprising: reconstructing, by an image processor, a CT image from spectral CT data; forming, by the image processor, a derivative image from the CT image using a first trained diffusion model; and displaying the derivative image.

Illustrative Embodiment 19. The method of Illustrative Embodiment 18, wherein reconstructing comprises reconstructing using a second trained diffusion model, the second trained diffusion model comprising a conditional diffusion model.

Illustrative Embodiment 20. The method of Illustrative Embodiment 19, wherein reconstructing comprises iteratively reconstructing with the second trained diffusion model receiving a second combined image of each iteration and outputting a second expected image, a CT scanner model receiving the second expected image and the spectral CT data and outputting a second iteration image, and the second iteration image and the second expected image forming the second combined image; and wherein forming comprises iteratively forming with the first trained diffusion model receiving a first combined image of each iteration and outputting a first expected image, a derivative physics model receiving the first expected image and outputting a first iteration image, and the first iteration image and the first expected image forming the first combined image.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(we) claim:

1. A system for computed tomography (CT) imaging, the system comprising:
a CT scanner for scanning a patient, the CT scanner configured to output data representing an interior region of the patient;
an image processor configured to reconstruct a CT object from the output data with a first machine-learned diffusion model and a CT scanner model, the image processor configured to reconstruct a derivative object from the CT object with a second machine-learned diffusion model and a derivative physics model; and
a display configured to display an image of the derivative object.

2. The system of claim 1, wherein the display is configured to display the image of the derivative object and the CT object.

3. The system of claim 1, wherein the image processor is configured to reconstruct the CT object as a spectral CT representation, and wherein the image processor is configured to reconstruct the derivative object as a material map, a monoenergetic object, or a virtual non-contrast object.

4. The system of claim 3, wherein the derivative object is a material map and wherein the second machine-learned diffusion model was configured by training for the reconstruction of the material map.

5. The system of claim 4, wherein the image processor is configured to reconstruct the material map and the monoenergetic object or the virtual non-contrast object, wherein a third machine-learned diffusion model is used for the reconstruction of the monoenergetic object or the virtual non-contrast object.

6. The system of claim 4, wherein the image processor is configured to reconstruct the material map with the second machine-learned diffusion model and an additional material map, wherein a third machine-learned diffusion model is used for the reconstruction of the additional material map.

7. The system of claim 1, wherein the CT scanner model comprises a physics model of the CT scanner, and wherein the first and second machine-learned diffusion models are operable with different physics models including the physics model of the CT scanner and the derivative physics model.

8. The system of claim 1, wherein the first machine-learned diffusion model comprises a conditional diffusion model.

9. The system of claim 8, wherein the conditional diffusion model comprises an input for anatomy identification, energy, resolution, sharpness, or noise levels.

10. The system of claim 1, wherein the derivative physics model comprises linear solutions of physical properties relating the CT object to the derivative object.

11. The system of claim 1, wherein the image processor is configured to reconstruct the CT object iteratively where, for each iteration, the CT scanner model relates the output data to an output of the first machine-learned diffusion model, where the output of the first machine-learned diffusion model is generated from the CT object; and
wherein the image processor is configured to reconstruct the derivative object iteratively where, for each iteration, the derivative physics model relates the CT object to an output of the second machine-learned diffusion model, where the output of the second machine-learned diffusion model is generated from the derivative object.

12. A method for computed tomography (CT) imaging, the method comprising:
scanning, by a spectral CT system, a patient, the scanning providing spectral CT data representing the patient;
reconstructing, by an image processor, a CT image from the spectral CT data using a first trained diffusion model;
forming, by the image processor, a derivative image from the CT image using a second trained diffusion model; and
displaying the derivative image.

13. The method of claim 12, wherein reconstructing comprises reconstructing iteratively using the first trained diffusion model and a physics model of the spectral CT system.

14. The method of claim 13, wherein reconstructing is operable using the first trained diffusion model and different physics models of different spectral CT systems.

15. The method of claim 12, wherein forming comprise forming iteratively using the second trained diffusion model and a derivative physics model.

16. The method of claim 15, wherein forming comprises forming the derivative image and an additional derivative image, the derivative image formed with the second trained diffusion model and the additional derivative image formed with a third trained diffusion model.

17. The method of claim 12, wherein the first and second trained diffusion models comprise conditional diffusion models, wherein reconstructing comprises inputting a first image characteristic to the conditional diffusion model of the first trained diffusion model, and wherein forming comprises inputting a second image characteristic to the conditional diffusion model of the second trained diffusion model.

18. A method for computed tomography (CT) imaging, the method comprising:
reconstructing, by an image processor, a CT image from spectral CT data;
forming, by the image processor, a derivative image from the CT image using a first trained diffusion model; and
displaying the derivative image.

19. The method of claim 18, wherein reconstructing comprises reconstructing using a second trained diffusion model, the second trained diffusion model comprising a conditional diffusion model.

20. The method of claim 19, wherein reconstructing comprises iteratively reconstructing with the second trained diffusion model receiving a second combined image of each iteration and outputting a second expected image, a CT scanner model receiving the second expected image and the spectral CT data and outputting a second iteration image, and the second iteration image and the second expected image forming the second combined image;
wherein forming comprises iteratively forming with the first trained diffusion model receiving a first combined image of each iteration and outputting a first expected image, a derivative physics model receiving the first expected image and outputting a first iteration image, and the first iteration image and the first expected image forming the first combined image.
